(19) United States
(12) Patent Application Publication
(10) Pub. No.: US 2012/0286062 A1
(43) Pub. Date: Nov. 15, 2012

(54) NETWORK BASED SPRINKLER CONTROLLER

(76) Inventors: David Sicotte, Draper, UT (US); Girish Ghimire, South Jordan, UT (US); Stefan Hamilton, Sandy, UT (US)

(21) Appl. No.: 13/104,817

(22) Filed: May 10, 2011

(51) Int. Cl. B67D 7/08

(52) U.S. Cl. 239/71

(57) ABSTRACT

A sprinkler system provides improved control to prevent over or under watering. The sprinkler system includes a networked controller which receives information from a control system. The control system may be a computer or Internet based server. The control system collects information from a various information sources relating to weather conditions for determining watering needs.

### BACKGROUND OF THE INVENTION

1. Field of the Invention

The present invention relates to a system for controlling a landscape sprinkler system. More specifically, it relates to a networked based control system which incorporates information from multiple online sources for determining a watering schedule.

2. Discussion of Related Art

Sprinkler systems are commonly used to water lawns and other plants within a landscaped area. A sprinkler system is necessary because the rainfall is insufficient or too inconsistent to maintain the grass and plants in good condition. A typical current sprinkler system 1 is illustrated in FIG. 1. The sprinkler system 1 connects a water supply 50 to a plurality of sprinkler zones 41, 42, 43. Each sprinkler zone 41, 42, 43 provides water in a desired pattern to a desired portion of the landscaped area. A set of valves 31, 32, 33 control the flow of water from the water supply 50 to the sprinkler zones 41, 42, 43. The valves 31, 32, 33 are controlled by a programmable controller 2. The programmable controller 2 is connected to the valves 31, 32, 33 by wires 21, 22, 23. An electrical signal is sent by the programmable controller 2 to the valves 31, 32, 33 to open and/or close the valves. The programmable controller 2 is programmed to control the valves 31, 32, 33 to provide water at certain days and times.

Typical sprinkler systems can be very inefficient and wasteful of water. The system 1 provides water at defined times without regard to the moisture needs of the plants. The amount of moisture required by the plants depends upon a variety of weather factors, including the amount of rainfall, the amount of sunshine, the temperature, the humidity, the soil conditions, etc. The typical sprinkler system does not take into consideration any of these factors. When programming the system, the times and amount of water are based upon average expectations for weather conditions. This can result in over or under watering; both of which can effect the health of the plants. In addition, over watering is wasteful of water, which is a precious resource in many areas. A good example of this is when the sprinkler system operates during a rainstorm.

Some systems have attempted to account for weather conditions. For example, a sprinkler system is known which has a rain gauge 62 and thermometer 61. The rain gauge 61 and thermometer 61 are connected to the programmable controller 2. Information from the rain gauge 62 and thermometer 61 are utilized in the programmable controller 2 to adjust the timing set in the sprinkler system. Of course, other types of sensors also could be used to measure other factors affecting the moisture needs of the plants. The use of multiple sensors, while improving the performance of the sprinkler system, would make the system much more complicated, expensive and difficult to use. Programming the system would be more difficult due to the number of factors which might be considered.

Programming a sprinkler system already can be difficult. A large number of factors must be set, including the days and times to water each zone and the amount of time each zone needs water. Some systems require the entire program schedule to be entered or reviewed to make any changes. Also, the location of the programmable controller 2 can make programming more difficult. The programmable controller 2 should be close to or within easy access to the valves 31, 32, 33 to be controlled. In a residence, the programmable controller 2 may be easily placed for programming. However, for systems in parks and athletic fields, access to the programmable controller 2 can be more difficult. Some systems have accounted for this problem by providing an external programmer 63 for programming the programmable controller 2. The information for controlling the programmable controller 2 is set within the external programmer 61. The external programmer 61 can then be connected to the programmable controller 2, either with a wire or wirelessly, to transfer the programming information. A single external programmable controller could be used to program a number of programmable controllers to control a large sprinkler system.

### SUMMARY OF THE INVENTION

The present invention overcomes many of the problems of existing sprinkler systems through the use of the power of a networked computer system, which might include the Internet, to program and control a sprinkler system. According to one aspect of the invention, a controller is connected to valves in a sprinkler system. The controller is connected to a network and receives signals from the network to operate the valves. The controller provides the signals necessary to operate the valves based upon information from the network.

According to another aspect of the invention, a computer connected to the network is used to set the programming of the sprinkler system. According to another aspect of the invention, the computer is a server on the network which is accessed through a browser. According to another aspect of the invention, the network is the Internet.

According to another aspect of the invention, additional information sources are used in programming the sprinkler system. These sources provide information regarding the weather conditions in order to more accurately provide the necessary water without over watering. According to one aspect of the invention, the information sources may include sensors for determining temperature, rain, and/or humidity. According to another aspect of the invention, the information sources may include weather information from a weather service, including predictions of future weather conditions. According to another aspect of the invention, the information sources may include calendar information including sunrise and sunset times. According to another aspect of the invention, the information sources may include one or more cameras to determine the condition of the plants being watered.

### BRIEF DESCRIPTION OF THE DRAWINGS

FIG. 1 illustrates the components of an existing sprinkler system.

FIG. 2 illustrates the components of a sprinkler system according to an embodiment of the present invention.

FIG. 3 illustrates components of an embodiment of a control server for use in a sprinkler system.

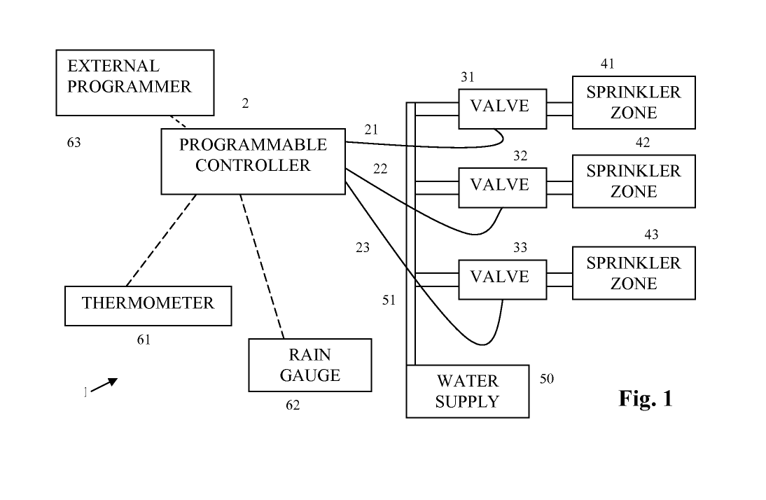

### DETAILED DESCRIPTION

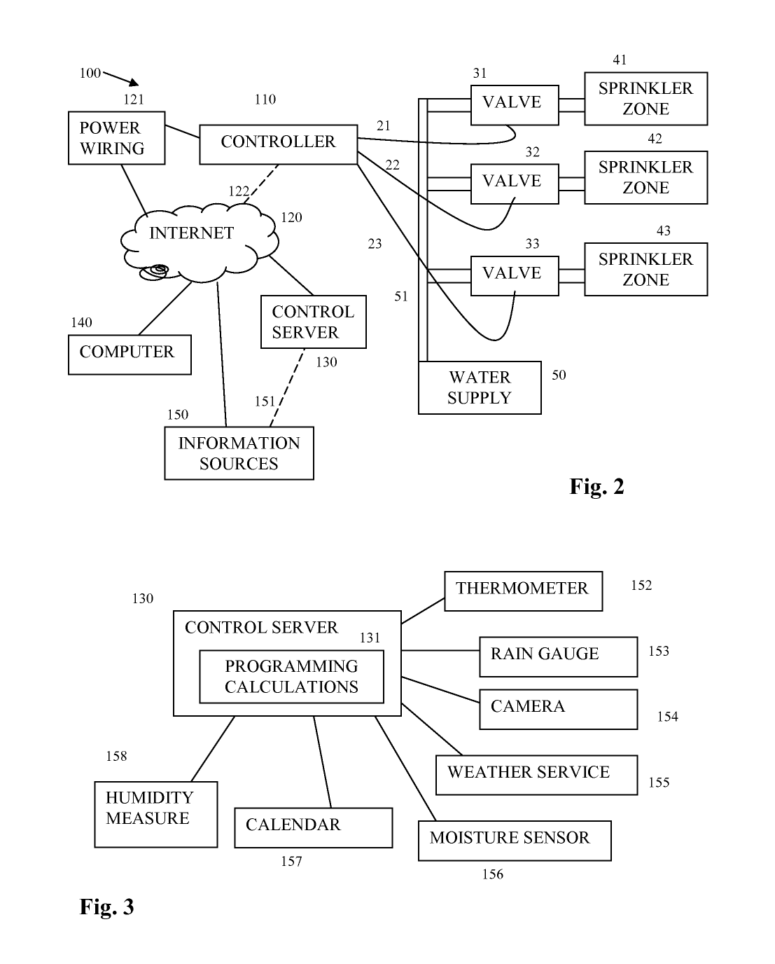

An improved sprinkler system 100 according to an embodiment of the invention is illustrated in FIG. 2. The valves 31, 32, 33, sprinkler zones 41, 42, 43, and water supply 50 are the same as in a typical existing sprinkler system. The valves 31, 32, 33 selectively provide water from the water supply 50 to the respective sprinkler zones 41, 42, 43. Although the system 100 is illustrated with three valves and zones, any number of zones can be included in the system. As in the typical sprinkler system, the valves 31, 32, 33 are controlled by signals provided on wires 21, 22, 23. The signals indicate when to open and close the valves.

The signals to the valves 31, 32, 33 in the system 100 according to an embodiment of the invention are provided by a controller 110. The controller 110 of this embodiment differs from the programmable controller 2 of the typical system in that it is not programmed to provide the times for operating the valves. Instead, the controller receives an input indicating a valve to operate or zone for watering. The controller, upon receipt of the input, provides the proper signal to the desired valve to open or close the valve. The programming for providing watering is set and controlled elsewhere in the system 100.

The controller 110 is connected to a network, such as the Internet 120 to receive the necessary inputs. According to an embodiment of the invention, the signals from the network are received though the power wiring 121 which provides power to the controller 110. As is known, an Ethernet connection can be created through power wiring in a building. For residential systems, such an operation is convenient, even when converting from an existing system. Existing programmable controllers already require power to operate. The controller 110 can simply replace the existing programmable controller and be plugged into the same power source. The system 100 requires a modem or router designed to create an powergrid Ethernet, which are commonly available. Alternatively, the controller 110 can be connected to the network 120 through a different wired or wireless connection 122. Of course, the use of a directly wired connection, either direct or through the power wiring 121, has improved security. Other types of security protections would be necessary for wireless connections to the controller 110.

According to the present invention, the programming and control or the sprinkler system is provided by another device connected to the network 120. According to one embodiment, the device is an appropriately programmed computer 140. The computer 140 includes software for operating a sprinkler system. The software which operates on the computer 140 determines the timing for operating the valves 31, 32, 33 based upon information inputted into the computer 140. The software can utilize the power of the computer to create complex watering schedules and/or adjustments to the schedule based upon prior watering and other conditions. When a sprinkler zone 41, 42, 43 is to be operated, the computer 140 sends a signal through the network 120 to the controller 110 to operate the proper valve 31, 32, 33. In this embodiment, the computer 140 could be a personal computer on a local network in the residence for which the sprinkler system operates. Although FIG. 2 illustrates the network as the Internet, in this embodiment, a local area network is sufficient.

According to another embodiment, the sprinkler system is operated by an Internet based service operated on a control server 130. The control server 130 may be any server connected to the Internet 120 which is operated through a browser. In this embodiment, the software for operating the sprinkler system 100 is contained on the control server 130. The software which operates on the control server 130 determines the timing for operating the valves 31, 32, 33 based upon information inputted into the control server 130. The software can utilize the power of the computer to create complex watering schedules and/or adjustments to the schedule based upon prior watering and other conditions. When a sprinkler zone 41, 42, 43 is to be operated, the control server 130 sends a signal through the Internet 120 to the controller 110 to operate the proper valve 31, 32, 33. The control server 130 can be used to operate multiple sprinkler systems. The control server 130 can be programmed in accordance with a desired watering schedule and/or based upon various inputs. The programming may be through accessing the control server 130 through an appropriate browser through the Internet 120 from a computer 140.

According to an embodiment of the present invention, the use of a computer 140 and/or control server 130 to provide programming for the sprinkler system allows more precise control for watering needs. The sprinkler system 100 includes additional information sources 150 for providing control of the sprinkler system 100. These information sources 150 are connected to the computer 140 and/or control server 130 through the Internet 120 to provide information to use in determining when and how much watering is needed. The information sources 150 may include a variety of sensors and information relating to weather conditions which affect the need for water.

FIG. 3 illustrates possible information sources for improved control of the sprinkler system. The control server 130 includes a set of calculations 131 which utilize information from various information sources to determine the watering schedule. The calculations can be set for any of the information sources and types of information which can be utilized. By providing control through the control server 130, a large number of possible control calculations can be accessed by various users. Also, the system can store information from the various sources over time to control the sprinkler system.

As illustrated in FIG. 3 and as is known in the prior art, a thermometer 152 and rain gauge 152 can be used to alter a watering schedule. The air temperature can affect the amount of water needed by plants. During hotter weather, more water is needed. Also, recent rain can reduce the amount of water needed. The thermometer 152 and rain gauge 153 can be associated with a specific location to be watered or with a general area around the location to be watered. The information may come from general sources which already determine such information.

The condition of the lawn and plants can be important to determining the amount of water needed. A camera 154, such as a video camera, can be placed to view the lawn and/or plants in the area to be watered. The image from the camera 154 can be processed to determine the condition of the lawn and plants as part of determining watering.

An input can be received from a weather service 155. Both past and predicted weather conditions may be important to watering. For example, if rain is predicted, watering may be postponed, even if there has not be recent rain. The amount of sunshine, both past and predicted, can also be used to adjust watering schedules. The weather service can also be used to predict temperatures in addition to past temperatures for adjusting watering schedules.

The amount of water in the soil is an important consideration for determining watering needs. A moisture sensor 156 can be utilized to determine the amount of moisture in the soil. As with other sensors, the moisture sensor may be related to a specific location and/or general area.

The amount of watering and the timing of watering may depend upon the time of year and the timing of sunrise and sunset. A calendar 157 can be used to make appropriate adjustments.

Similar to the moisture sensor 156 for the ground, a humidity sensor 158 can be used to measure the humidity of the air.

The information sources 150 illustrated in FIG. 3 are merely examples of information which could be used to provide control for the sprinkler system. A large variety of information sources 150 can be available from the Internet and could be used with appropriate programming to control the sprinkler system.

The software operating the controller 110 can be updated through a transmission from the network 120 as necessary for maintaining and improving operation.

Having disclosed at least one embodiment of the present invention, various adaptations, modifications, additions, and improvements will be readily apparent to those of ordinary skill in the art. Such adaptations, modifications, additions and improvements are considered part of the invention which is only limited by the several claims attached hereto.

1. A control system for a sprinkler system, wherein the sprinkler system includes a plurality of sprinkler heads, a plurality of valves and a plurality of pipes connecting each valve to one or more sprinkler heads, the control system comprising:
a control server generating an operating schedule identifying times for operation of the valves of the sprinkler system and for transmitting information relating to the operating schedule;
a controller electrically attached to the valves for receiving the information relating to the operating schedule and providing signals to the valves for operating the valves between an on position and an off position based upon the operating schedule; and
a network connecting the control sever and controller for transmission of the information relating to the operating schedule from the control server to the controller.

2. The control system according to claim 1, wherein the network includes a global network.

3. The control system according to claim 2, wherein the control server includes a server on the global network having software operable through a website.

4. The control system according to claim 1 further comprising a computer connected to the network communicating with the control server providing information for generating the operating schedule.

5. The control system according to claim 1 further comprising at least one data input connected to the network communicating with the control server providing information for generating the operating schedule.

6. The control system according to claim 5 wherein the at least one data input includes a plurality of data inputs.

7. The control system according to claim 5, wherein the at least one data input includes a data input providing information relating to at least one of past weather conditions and projected weather conditions.

8. The control system according to claim 5, wherein the at least one data input includes at least one of a temperature sensor, a rain sensor, a humidity sensor, a schedule of sun rise and sunset times, and a weather forecast.

9. The control system according to claim 5, wherein the at least one data input includes a visual input of at least a portion of an area covered by the sprinkler system.

10. The control system according to claim 5, wherein the at least one data input includes data obtained from a public weather information source.

11. A control system for a plurality of sprinkler systems, wherein each of the sprinkler systems includes a plurality of sprinkler heads, a plurality of valves and a plurality of pipes connecting each valve to one or more sprinkler heads, the control system comprising:
a control server generating an operating schedule identifying times for operation of the valves of each of the plurality of the sprinkler systems and for transmitting information relating to the operating schedule;
a plurality of controllers, each of the controllers being electrically attached to valves of a corresponding one of the plurality of sprinkler systems, each of the controllers receiving at least a portion of the information relating to the operating schedule and providing signals for operating respective valves between an on position and an off position based upon the operating schedule; and
a network connecting the control sever and the plurality of controllers for transmission of at least a portion of the information relating to the operating schedule from the control server to each of the plurality of controllers.

12. The control system according to claim 11, wherein the network includes a global network.

13. The control system according to claim 12, wherein the control server includes a server on the global network having software operable through a website.

14. The control system according to claim 13, wherein the control server includes an access controller for controlling access to a portion of the operating schedule.

15. The control system according to claim 14, wherein the access controller requires entry of user identification prior providing access to a portion of the operating schedule.

16. The control system according to claim 11 further comprising at least one data input connected to the network communicating with the control server providing information for generating the operating schedule.

17. The control system according to claim 16, wherein the at least one data input includes a data input providing information relating to at least one of past weather conditions and projected weather conditions.

18. The control system according to claim 16, wherein the at least one data input includes a first data input associated with a first one of the sprinkler systems and a second data input associated with a second one of the sprinkler systems.

19. The control system according to claim 16, wherein the at least one data input includes a visual input of at least a portion of an area covered by at least one of the plurality of sprinkler systems.
